(19) United States
(12) Patent Application Publication
(10) Pub. No.: US 2008/0286413 A1
(43) Pub. Date: Nov. 20, 2008

(54) Making Process of Extract Containing Ingredients of a Radish and a Pumpkin, and Making Process of Granules and Pills by Using the Extract

(75) Inventor: Chun Ja Lee, Busan (KR)

Correspondence Address: BIRCH STEWART KOLASCH & BIRCH, PO BOX 747, FALLS CHURCH, VA, 22040-0747, US

(73) Assignee: Chun Ja LEE, Busan (KR)

(21) Appl. No.: 11/629,534

(22) PCT Filed: Jun. 15, 2005
(86) PCT No.: PCT/KR05/01835

§ 371 Date: Dec. 14, 2006

(30) Foreign Application Priority Data
Jun. 15, 2004 (KR) 10-2004-0043837

(51) Int. Cl. A23L 2/12; A23L 2/10

(52) U.S. Cl. 426/52; 426/489; 426/285

(57) ABSTRACT

The present invention relates to a method for preparing an extract containing radish and pumpkin ingredients, and a process for preparing granules and pills with the extract. More particularly, the present invention relates to a method for preparing an extract from radishes, pumpkins, Welsh onions, cabbages, radish seeds, radish leaves and pumpkin seeds, which allows the main ingredients of radishes and pumpkins to be more effectively ingested, as well as a method for preparing the prepared extract into granules and pills which are easier to ingest.

### TECHNICAL FIELD

The present invention relates to a method for preparing an extract containing the ingredients of radish and pumpkin, and a process for preparing granules and pills with the extract. More particularly, the present invention relates to a method for preparing an extract from radishes, pumpkins, welsh onions, cabbages, radish seeds, radish leaves and pumpkin seeds, which allows the main ingredients of radishes and pumpkins to be more effectively ingested, as well as a method for preparing the prepared extract into granules and pills which are easier to ingest.

### BACKGROUND ART

Generally, radishes are rich in vitamin C so that they serve as a vitamin source in winter. Also, radish roots contain enzyme diastase so that they function to promote digestion. Radishes are used in various applications, such as radish kimchi, chopped radish kimchi, dried radish slices, and radish pickles, and radish seeds are medically used as expectorants and stomachics.

Also, radishes are known to be excellent in digestive and poison-neutralizing actions and to show a pharmacological effect property next to wild ginseng in increasing vigor. In addition, because of their poison-neutralizing effect, they match with alcoholic drinks, raw fish slices, wheat food and the like.

Regarding the pharmacological effects of radishes, the drinking of juice squeezed from radishes shows antitussive, stanching, disinfecting and fever-alleviating effects. Also, the ingestion of boiled radishes leads to the reduction of phlegm and indigestion.

Moreover, radishes have not only starch-digesting enzymes, such as diastase, but also proteases so that they promote digestion. Also, it is beneficial that meats or raw fish slices are eaten with radishes or juice squeezed from radishes. Furthermore, radish juice performs an expectorant action of reducing phlegm, and thus, it is beneficial to eat a radish juice containing glutinous rice jelly when having a cold. Also, since radishes have a poison-neutralizing action of neutralizing nicotine, it is beneficial for smokers to frequently eat radishes. In addition, radishes are known to have waste material removal, anti-inflammatory and diuretic actions, thus lowering blood pressure, and to have the effect of removing gallstones, thus preventing cholelithiasis. Radish leaves are rich in vitamin C and contain minerals, such as potassium and calcium, and radish seeds also contain vitamins B1 and B2, sodium, and the like.

Generally, a pumpkin, which is an annual climbing plant belonging to the Cucurbitaceae family, is widely known as eco-friendly food which is cultivated more easily than other vegetables and has strong resistance to dry weather and diseases so as to need little or no spreading of agricultural chemicals.

Pumpkins and pumpkin seeds are known to be rich in lecithin and essential amino acids making a head better, linoleic acid having the effects of lowering blood pressure and preventing atherosclerosis, and carotinoid pigments having anticancer actions, and to be effective in diuretic and anticancer actions.

Also, they are known to be rich in vitamin A so that they strengthen mucous membranes and increases resistance to a cold. In addition, they keep the body warm so that they are very beneficial to a person with a cold.

However, when squeezing juice from radishes and pumpkins in order to use the radish and pumpkin juices for the above-described purposes, there is a problem in that sulfur compounds and glycosides of sulfur compounds, which give the peculiar unpleasant odor and hot taste of radishes, are produced and volatilized upon the breakdown of radish tissue by the action of enzymes contained in radishes themselves. This makes the drinking of the squeezed juice difficult.

Meanwhile, Welsh onions and cabbages, which are generally added to food, also contain ingredients useful to the human body, but have their peculiar unpleasant odor and hot taste like radishes or pumpkins. This makes it difficult to drink juice squeezed from Welsh onions and cabbages.

### DISCLOSURE OF INVENTION

The present invention has been made to solve the above-described problems, and it is an object of the present invention to provide a method for preparing an extract containing the ingredients of radishes and pumpkins, which makes it easy to ingest the ingredients of radishes and pumpkins, as well as a method for preparing the prepared extract into granules and pills, which allows for users to easily take the extract according to the use of the extract.

To achieve the above object, in one embodiment, the present invention provides a method for preparing an extract containing the ingredients of radishes and pumpkins, the method comprising: a washing step of cleaning radishes, radish leaves, pumpkins, Welsh onions and cabbages cut into a size of 1-5 cm together with radish seeds and pumpkin seeds; a vegetable juice extraction step of extracting vegetable juice from the washed materials by squeezing; a first sterilization step of sealing the extracted vegetable juice in vacuum and sterilizing the sealed juice by heating at 75-90° C.; a filtration step of removing impurities from the sterilized vegetable juice; a second sterilization step of rapidly heating the filtered vegetable juice at 100-110° C. for 1-3 minutes; and a cooling step of increasing the viscosity of the heated vegetable juice by rapid cooling at a temperature of −10° C. to −20° C.

In another embodiment, the present invention provides a method for preparing an extract containing the ingredients of radishes and pumpkins, the method comprising: a washing step of cleaning radishes, radish leaves, pumpkins, Welsh onions and cabbages cut into a size of 1-5 cm together with radish seeds and pumpkin seeds; a first concentrating step of heating the washed materials in an extractor at 100-120° C. for 6-8 hours to make a concentrate; and a second concentrating step of heating the first concentrate at 60-70° C. to a solid content of about 30-45 Brix.

In still another embodiment, the present invention provides a method for preparing granules with an extract containing the ingredients of radishes and pumpkins, the method comprising: a washing step of cleaning radishes, radish leaves, pumpkins, Welsh onions and cabbages cut into a size of 1-5 cm together with radish seeds and pumpkin seeds; a freeze-drying step of drying the washed materials at a temperature of −10° C. to −20° C.; a hot-air drying step of drying the freeze-dried material with hot air at 50-60° C.; a crushing step of crushing the hot-air dried material to make powder; a mixing step of mixing the crushed powder with an extract containing the ingredients of radishes and pumpkins at a weight ratio of 1:1 and then sterilizing the mixture by heating at 50-60° C. to produce a mixture with high viscosity; a culturing step of fermenting the mixture with Monascus sp. for 12-24 hours to culture Monacolin K; an addition step of adding vitamin C to the culture; and a granulation step of heating the resulting material to a water content of about 10% so as to form granules.

In yet another embodiment, the present invention provides a method for preparing pills with an extract containing the ingredients of radishes and pumpkins, the method comprising: a washing step of cleaning radishes, radish leaves, pumpkins, Welsh onions and cabbages cut into a size of 1-5 cm together with radish seeds and pumpkin seeds; a freeze-drying step of drying the washed materials at a temperature of −10° C. to −20° C.; a hot-air drying step of drying the freeze-dried material with hot air at 50-60° C.; a crushing step of crushing the hot-air dried material to make powder; a mixing step of mixing the crushed powder with an extract containing the ingredients of radishes and pumpkins at a weight ratio of 1:1 and then sterilizing the mixture by heating at 50-60° C. to produce a mixture with high viscosity; and a pill formation step of drying the mixture to a water content of about 1% and then forming the dried material into pills with a given size.

As described above, according to the present invention, radishes and pumpkins, which are frequently ingested, are prepared into an extract which allows the main ingredients of radishes and pumpkins to be more effectively ingested. Also, in order to allow the prepared extract to be more easily taken, the extract is used to prepare granules and pills. Thus, the present invention allows anyone to ingest the extract, thus contributing to health promotion. Also, the present invention increases the consumption of radishes and pumpkins, resulting in an increase in the income of farmers who produce radishes and pumpkins.

### BRIEF DESCRIPTION OF DRAWINGS

FIG. 1 is a flow chart showing a method for preparing an extract containing the ingredients of radishes and pumpkins according to one embodiment of the present invention.

FIG. 2 is a flow chart showing a method for preparing an extract containing the ingredients of radishes and pumpkins according to another embodiment of the present invention.

FIG. 3 is a flow chart showing a method for preparing granules with an extract containing the ingredients of radishes and pumpkins according to the present invention.

FIG. 4 is a flow chart showing a method for preparing pills with an extract containing the ingredients of radishes and pumpkins according to the present invention.

### BEST MODE FOR CARRYING OUT THE INVENTION

Hereinafter, preferred embodiments of the present invention will be described in detail with reference to the accompanying drawings.

### Example 1

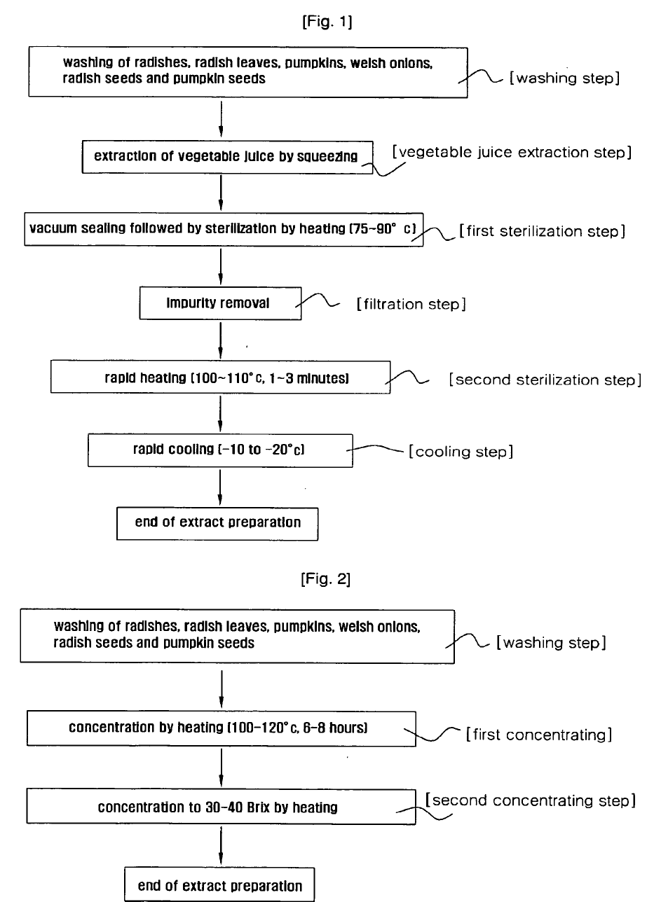

FIG. 1 is a flow chart showing a method for preparing an extract containing the ingredients of radishes and pumpkins according to Example 1 of the present invention.

First, radishes, radish leaves, pumpkins, Welsh onions, cabbages, radish seeds and pumpkin seeds, which were selected carefully, are washed clean by shower water. Then, the washed materials are adjusted to a weight ratio of 20% radishes, 20% radish leaves, 20% pumpkins, 10% Welsh onions, 10% cabbages, 10% radish seeds and 10% pumpkin seeds, and the radishes, radish leaves and the pumpkins are cut into a size of 1-5 cm.

The ratio between the materials can be adjusted within a range which does not greatly deviate from the above-described ratio.

The washed materials are well mixed with each other and then squeezed to extract the vegetable juice thereof.

The extracted vegetable juice is sealed in vacuum and sterilized by heating at 75-90° C.

The sterilized vegetable juice is filtered through filter paper or a network to remove impurities, radish seeds and pumpkin seeds contained in the vegetable juice.

The filtered vegetable juice is additionally sterilized by rapid heating at 100-110° C. for 1-3 minutes.

Then, the sterilized vegetable juice is rapidly cooled at a temperature of −10° C. to −20° C., thus preparing an extract containing the ingredients of radishes and pumpkins.

The extracted thus prepared is preferably stored in general packages, such as tea packs and retort pouches.

### Example 2

FIG. 2 is a flow chart showing a method for preparing an extract containing the ingredients of radishes and pumpkins according to Example 2 of the present invention.

As in the washing step of Example 1, radishes, radish leaves, pumpkins, Welsh onions, cabbages, radish seeds and pumpkin seeds, which were selected carefully, are washed clean by shower water. Then, the washed materials are adjusted to a weight ratio of 20% radishes, 20% radish leaves, 20% pumpkins, 10% Welsh onions, 10% cabbages, 10% radish seeds and 10% pumpkin seeds, and the radishes, radish leaves and the pumpkins are cut into a size of 1-5 cm.

Then, the washed materials are heated in an extractor or a boiling water bath at 100-120° C. for 6-8 hours to make a first concentrate.

Next, the first concentrate is heated at a temperature of 60-70° C. to a solid content of about 30-45 Brix to make a second concentrate, thus preparing an extract containing the ingredients of radishes and pumpkins by a different method from Example 1.

### Example 3

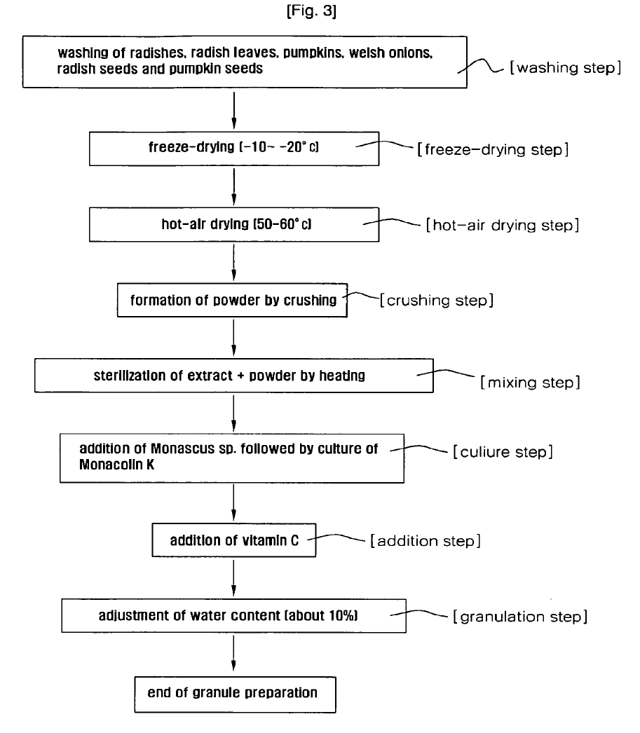

FIG. 3 is a flow chart showing a method for preparing granules with an extract containing the ingredients of radishes and pumpkins according to Example 3 of the present invention.

First, radishes, radish leaves, pumpkins, Welsh onions, cabbages, radish seeds and pumpkin seeds, which were selected carefully, are washed clean by shower water. Then, the washed materials are adjusted to a weight ratio of 20% radishes, 20% radish leaves, 20% pumpkins, 10% Welsh onions, 10% cabbages, 10% radish seeds and 10% pumpkin seeds, and the radishes, radish leaves and the pumpkins are cut into a size of 1-5 cm.

Then, the washed materials are dried by freezing at a temperature of −10 to −20° C.

Next, the freeze-dried materials are additionally dried with hot air at 50-60° C. to make them hard.

The hot-air dried materials are uniformly mixed with each other and crushed to form powder, and the formed powder is mixed with the extract prepared in Example 1 or 2 at a ratio of 1:1. The mixture solution is sterilized by heating at 50-60° C. so as to increase the viscosity of the mixture.

Then, the mixture is added with Monascus sp. and fermented for 12-24 hours to culture Monacolin K.

To the culture, vitamin C is added.

The resulting mixture is adjusted to a water content of about 10% by heating, thus preparing granules.

### Example 4

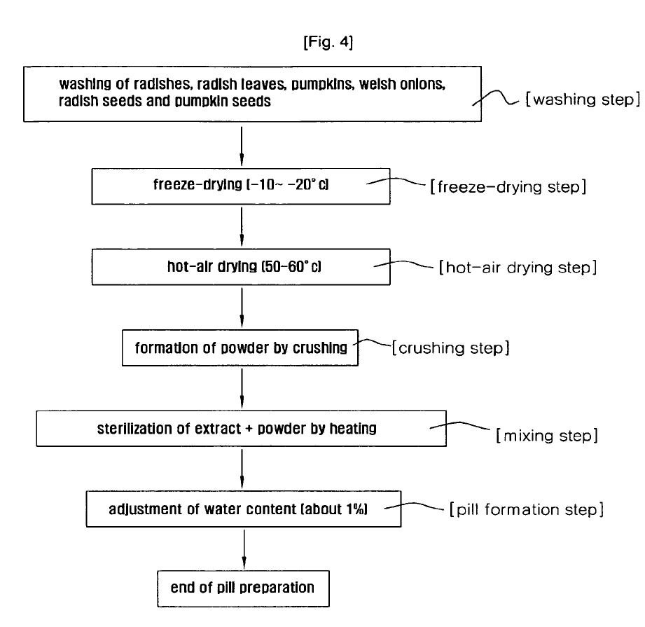

FIG. 4 is a flow chart showing a method for preparing pills with an extract containing the ingredients of radishes and pumpkins according to Example 4 of Example 4.

First, radishes, radish leaves, pumpkins, Welsh onions, cabbages, radish seeds and pumpkin seeds, which were selected carefully, are washed clean by shower water. Then, the washed materials are adjusted to a weight ratio of 20% radishes, 20% radish leaves, 20% pumpkins, 10% Welsh onions, 10% cabbages, 10% radish seeds and 10% pumpkin seeds, and the radishes, radish leaves and the pumpkins are cut into a size of 1-5 cm.

Then, the washed materials are dried by freezing at a temperature of −10 to −20° C.

Next, the freeze-dried materials are additionally dried with hot air at 50-60° C. to make them hard.

The hot-air dried materials are uniformly mixed with each other and crushed to form powder, and the formed powder is mixed with the extract prepared in Example 1 or 2 at a ratio of 1:1. The mixture solution is sterilized by heating at 50-60° C. so as to increase the viscosity of the mixture.

The sterilized mixture is adjusted to a water content of about 1% and then formed into easy-to-take round pills.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for preparing an extract containing the ingredients of radishes and pumpkins, the method comprising:
a washing step of cleaning radishes, radish leaves, pumpkins, Welsh onions and cabbages cut into a size of 1-5 cm together with radish seeds and pumpkin seeds;
a vegetable juice extraction step of extracting vegetable juice from the washed materials by squeezing;
a first sterilization step of sealing the extracted vegetable juice in vacuum and sterilizing the sealed juice by heating at 75-90° C.;
a filtration step of removing impurities from the sterilized vegetable juice;
a second sterilization step of rapidly heating the filtered vegetable juice at 100-110° C. for 1-3 minutes; and
a cooling step of increasing the viscosity of the sterilized vegetable juice by rapid cooling to a temperature of −10 to −20° C.

2. A method for preparing an extract containing the ingredients of radishes and pumpkins, the method comprising:
a washing step of cleaning radishes, radish leaves, pumpkins, Welsh onions and cabbages cut into a size of 1-5 cm together with radish seeds and pumpkin seeds;
a first concentrating step of heating the washed materials in an extractor at 100-120° C. for 6-8 hours to make a concentrate; and
a second concentrating step of heating the first concentrate at 60-70° C. to a solid content of about 30-45 Brix.

3. A method for preparing granules with an extract containing the ingredients of radishes and pumpkins, the method comprising:
a washing step of cleaning radishes, radish leaves, pumpkins, Welsh onions and cabbages cut into a size of 1-5 cm together with radish seeds and pumpkin seeds;
a freeze-drying step of drying the washed materials at a temperature of −10° C. to −20° C.;
a hot-air drying step of drying the freeze-dried materials with hot air at 50-60° C.;
a crushing step of crushing the hot-air dried material to make powder;
a mixing step of mixing the crushed powder with an extract containing the ingredients of radishes and pumpkins at a weight ratio of 1:1 and then sterilizing the mixture by heating at 50-60° C. so as to produce a mixture with high viscosity;
a culturing step of fermenting the mixture with Monascus sp. for 12-24 hours to culture Monacolin K;
an addition step of adding vitamin C to the culture; and
a granulation step of heating the resulting material to a water content of about 10% so as to form granules.

4. A method for preparing pills with an extract containing the ingredients of radishes and pumpkins, the method comprising:
a washing step of cleaning radishes, radish leaves, pumpkins, Welsh onions and cabbages cut into a size of 1-5 cm together with radish seeds and pumpkin seeds;
a freeze-drying step of drying the washed materials at a temperature of −10° C. to −20° C.;
a hot-air drying step of drying the freeze-dried materials with hot air at 50-60° C.;
a crushing step of crushing the hot-air dried materials to make powder;
a mixing step of mixing the crushed powder with an extract containing the ingredients of radishes and pumpkins at a weight ratio of 1:1 and then sterilizing the mixture by heating at 50-60° C. so as to produce a mixture with high viscosity; and
a pill formation step of drying the mixture to a water content of about 1% and then forming the dried material into pills with a given size.

5. The method of claim 3, wherein the extract added in the mixing step is an extract prepared by the method of any one of claims 1 or 2.

6. The method of claim 4, wherein the extract added in the mixing step is an extract prepared by the method of any one of claims 1 or 2.
